(19) United States
(12) Patent Application Publication
(10) Pub. No.: US 2003/0048021 A1
(43) Pub. Date: Mar. 13, 2003

(54) Disk type D.C. motor having a non-ferrous stator

(76) Inventor: Orville Phillip Frazee, Indian Hills, CO (US)

Correspondence Address: WILLIAM E HEIN, PO BOX 335, LOVELAND, CO, 80539-0335, US

(21) Appl. No.: 09/954,597

(22) Filed: Sep. 12, 2001

(51) Int. Cl. H02K 1/00

(52) U.S. Cl. 310/180

(57) ABSTRACT

A disk type D.C. motor having a non-ferrous stator includes a rotor attached perpendicular to the axis of a motor shaft rotatable with respect to a motor case. An even plurality of permanent magnets are encased in the rotor and are oriented such that in a radial view they show sequentially alternating pole face polarities. A number of pairs of pole pieces corresponding to the number and spacing of the magnets are mounted to the case in a radial distribution such that the pairs of pole pieces face each other. The pairs of pole pieces are positioned on opposite sides of, and firmly in contact with, a core and are also in close proximity to, but not in contact with, the rotor. A coil is wound around the core and between each of the pairs of pole pieces such that an electric current flowing is each of the coils induces a magnetic north-south polarity in each of the pairs of pole pieces. Driving circuitry for selectively applying voltage pulses to each of the coils permits the speed of the motor to be varied.

### FIELD OF THE INVENTION

This invention relates generally to D.C. motors and, more particularly, to a relatively low speed disk type D.C. motor having a non-ferrous stator and that is controllable and light weight and that exhibits high output torque.

### BACKGROUND AND SUMMARY OF THE INVENTION

Disk type motors are known in the prior art, as typified by those taught in U.S. Pat. No. 4,551,645 to Takahashi et al. and U.S. Pat. No. 5,144,183 to Farrenkopf. These prior art motors are typically small, low power, and low voltage synchronous motors. They are used primarily in disk and phonograph drives, as well as other electronic applications. Larger, more powerful motors utilize coils that are placed on either one side or both sides of the housing facing the rotor. In order to provide a closed magnetic flux path, this configuration requires that the motor housing be constructed of a magnetic material. This results in a relatively heavy motor that is difficult to assemble. Problems with large radius rotors that are inherently unstable and the one-side application of force have severely limited the size and power of these prior art disk type motors.

It would therefore be advantageous to provide a disk type D.C. motor having a non-ferrous stator and having a rotor attached perpendicular to the axis of a motor shaft rotatable with respect to a motor case. An even plurality of magnets are encased in the rotor and are oriented such that in a radial view they show sequentially alternating pole face polarities. A number of pairs of pole pieces corresponding to the number and spacing of the magnets are mounted to the case in a radial distribution such that the pairs of pole pieces face each other. The pairs of pole pieces are positioned on opposite sides of and firmly in contact with a core and are also in close proximity to, but not in contact with, the rotor. A coil is wound around the core and between each of the pairs of pole pieces such that an electric current flowing in each of the coils induces a magnetic north-south polarity in each of the pairs of pole pieces. External driving circuitry for selectively applying voltage pulses to each of the coils facilitates control of the motor speed.

### BRIEF DESCRIPTION OF THE DRAWINGS

FIG. 1 is a sectional view of a motor constructed in accordance with the present invention, taken along the central axis thereof.

FIG. 2 is a plan view of the rotor of the motor of FIG. 1, illustrating the alternating pole faces of magnets employed therein.

FIG. 3 is a plan view of the inner case of the motor of FIG. 1 with the rotor removed.

FIG. 4 is a plan view of the motor of FIG. 1, cut away to illustrate the relative radial positions of the components thereof.

FIG. 5 is a detailed schematic diagram of a pulse generator circuit for electrically driving the coils of the motor of FIG. 1, the pulse generator circuit producing two variable and controllable output pulses that are 180 degress out of phase with each other.

FIG. 6 is a detailed schematic diagram of a coil driver circuit for amplifying and reversing the polarity of the two pulses produced by the pulse generator circuit of FIG. 5.

FIG. 7 is a waveform diagram illustrating the waveform of voltage vs. time at the output terminal #1 of the pulse generator circuit of FIG. 5.

FIG. 8 is a waveform diagram illustrating the waveform of voltage vs. time at the output terminal #2 of the pulse generator circuit of FIG. 5.

### DETAILED DESCRIPTION OF THE PREFERRED EMBODIMENT

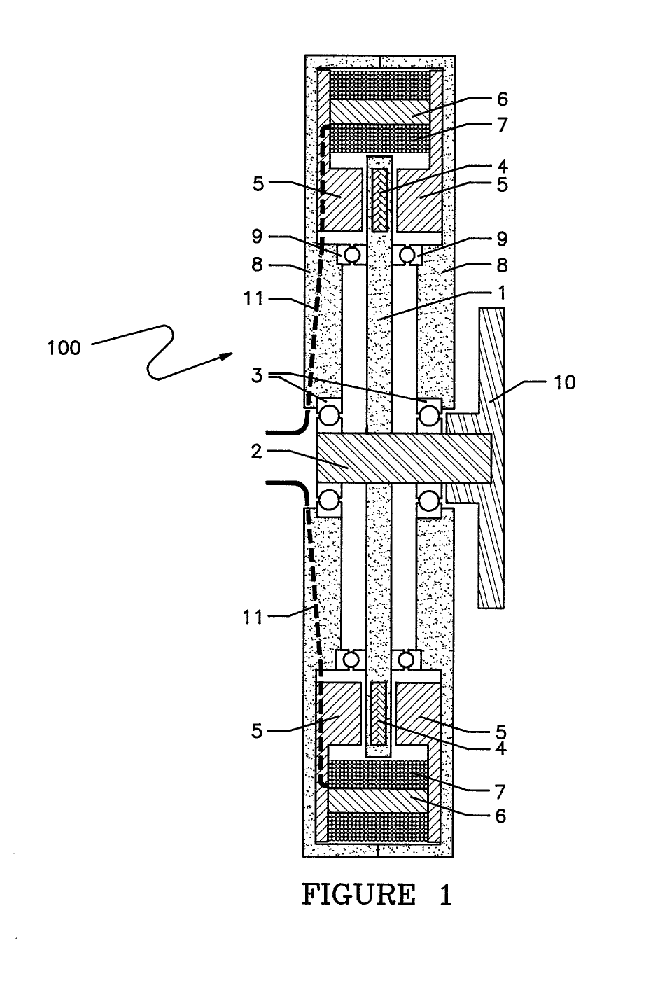

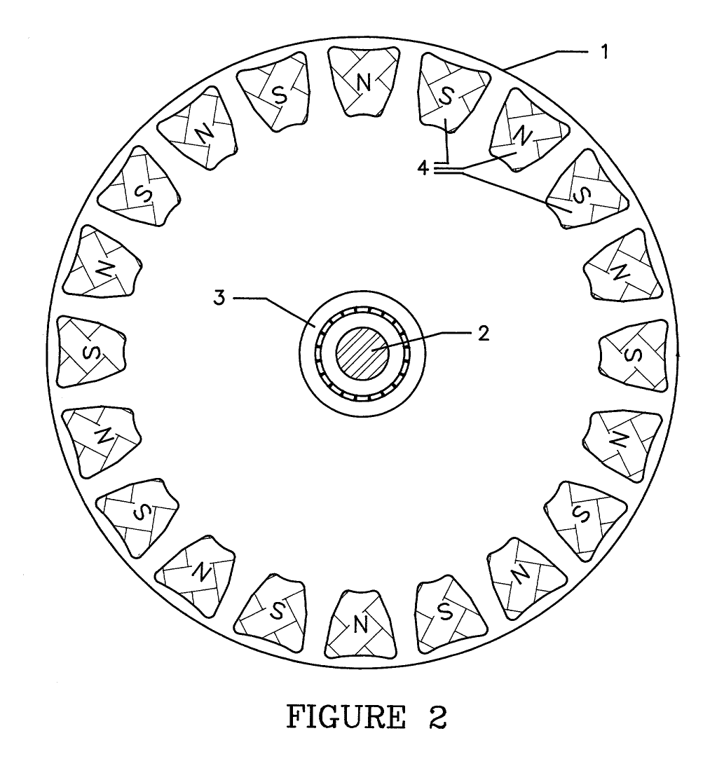

Referring now to FIG. 1, there is shown a sectional diagram of a motor 100 constructed in accordance with the present invention. Motor 100 has a rotor 1 that is attached perpendicular to the axis of a motor shaft 2 that rotates relative to a motor case 8 by means of a pair of shaft bearings 3. Encased within rotor 1 are an even plurality of magnets 4. The magnets 4 are oriented such that when viewed radially they show sequentially alternating north and south pole faces, as illustrated in FIG. 2. A plurality of pole pieces 5, in like number and spacing as the plurality of magnets 4, are mounted in a radial distribution to case 8 such that they face each other. Each pair of facing pole pieces 5 are mounted in close proximity to, but not in contact with, rotor 1. Each pair of facing pole pieces 5 are also positioned on opposite sides of, and in firm contact with, a core 6. Pole pieces 5 and core 6 are constructed of a suitable ferromagnetic material. A coil 7 is wound around core 6 and between each pair of pole pieces 5 in a manner such that an electric current flowing in the coil 7 induces a magnetic north-south polarity in the pairs of pole pieces 5. If the polarity of the pairs of pole pieces 5 and the polarity of the magnets 4 which they face in rotor 1 is the same, i.e. north-north and south-south, a repulsive force between them will be developed. This repulsive force will cause rotor 1 to rotate with respect to case 8 around shaft 2. At the same time, an attractive force will be developed between magnet 4 and the second one of each pair of pole pieces 5 associated with an adjacent coil 7 if that coil 7 has a current flowing that will cause the second one of the pair of pole pieces 5 associated with that coil 7 to assume the opposite polarity of the magnet 4 under consideration, i.e. north-south and south-north. The repulsive force will diminish as the distance between the magnet 4 and the first one of the pair of pole pieces 5 increases, while the attractive force increases as the distance between the magnet 4 and the second one of the pair of pole pieces 5 decreases. These two components of force are additive, which further increases the force exerted to cause rotor 1 to rotate. If all of the coils 7 are energized simultaneously in the proper polarity, a rotational force will be imparted to rotor 1 that is approximately equal to the force of one of the magnets 4, multiplied by the number of magnets 4. This force amplification can result in the production of a very high output torque by motor 100.

Case 8 of motor 100 is constructed of a non-magnetic material since it is desirable to concentrate the flux path between opposing faces of each of the pairs of pole pieces 5. Thus, light weight materials such as aluminum alloys, composite materials, etc. may be used to fabricate case 8. Rotor 1 may be fabricated entirely of a non-magnetic material or, alternatively, of a combination of non-magnetic and ferromagnetic materials so long as any such ferromagnetic material is sufficiently distanced from the pole pieces 5 to avoid distorting or short circuiting the magnetic field produced thereby. A pair of thrust bearings 9 positioned peripherally between case 8 and rotor 1 serves to stabilize rotor 1 and to permit close mechanical tolerances between adjacent moving components of motor 100, thus facilitating the construction of motors of large overall diameter.

Motor 100 may include an output flange 10 to which a driven member may be attached. For example, in the case of an electric vehicle in which each wheel is driven by a separate motor, the wheel would be attached to output flange 10, and the opposite side of case 8 would be constrained by an appropriate structural member. Thus, motor 100 of the present invention would occupy only the physical space assigned to a conventional disk brake mechanism, the function of which can be accomplished by regenerative braking through motor 100 and by supplemental mechanical braking, if needed. The proper use of O-rings and shaft seals will render motor 100 weatherproof, if desired. Other applications for motor 100 of the present invention include motor scooter propulsion, grinding turntables, and fans, for example. If desired, motor 100 may easily be constructed to be symmetrical about a central plane perpendicular to shaft 2, with the exception of shaft 2 and output flange 10.

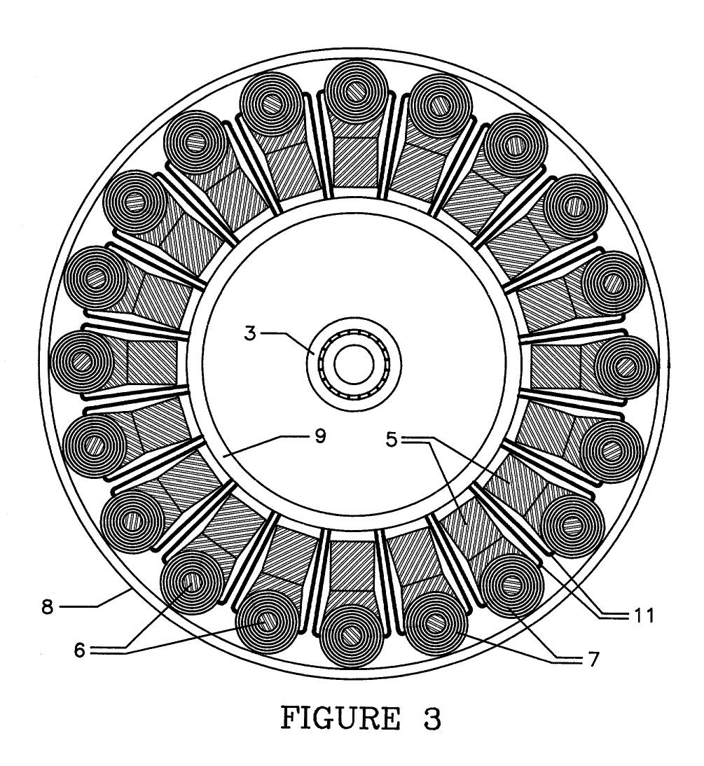

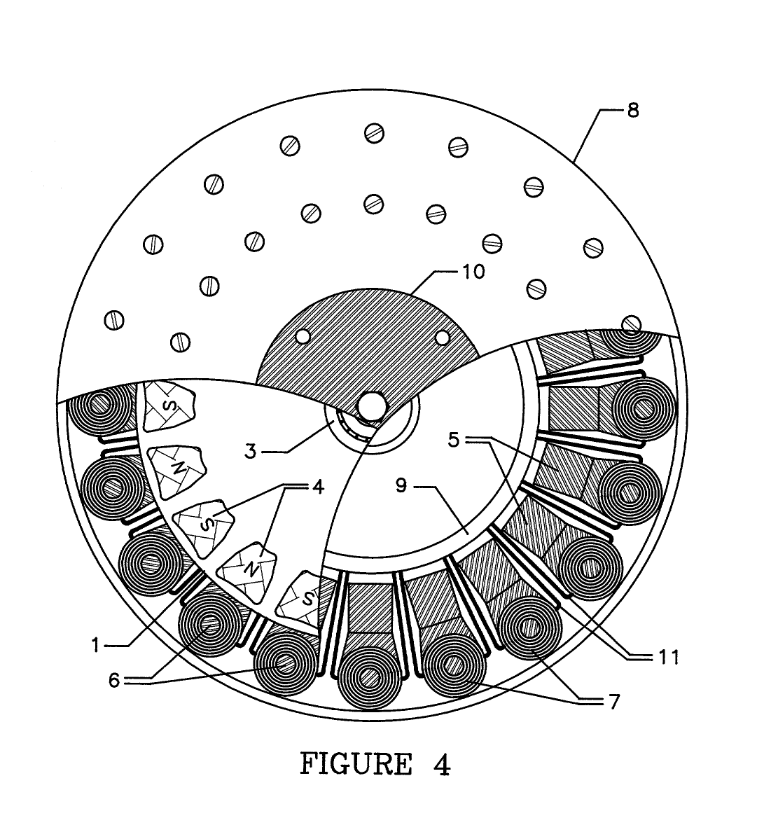

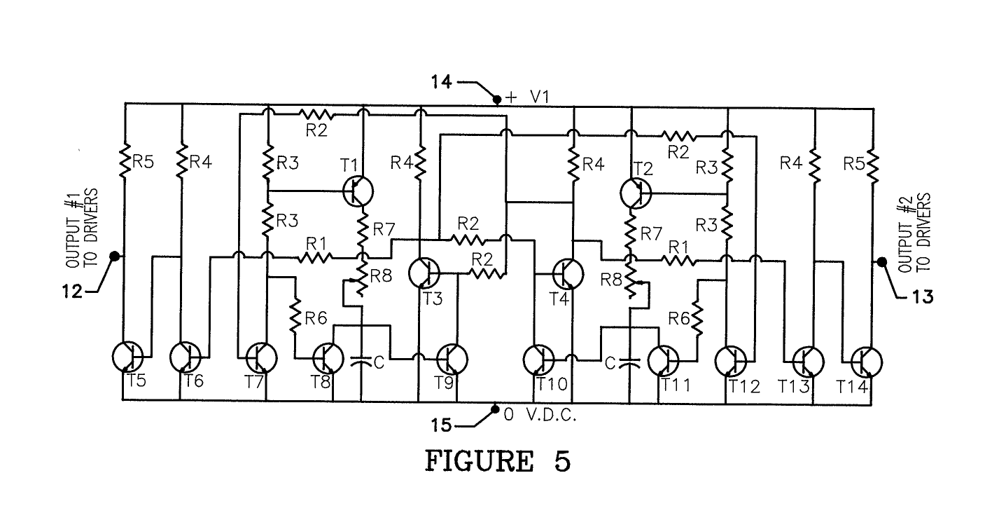

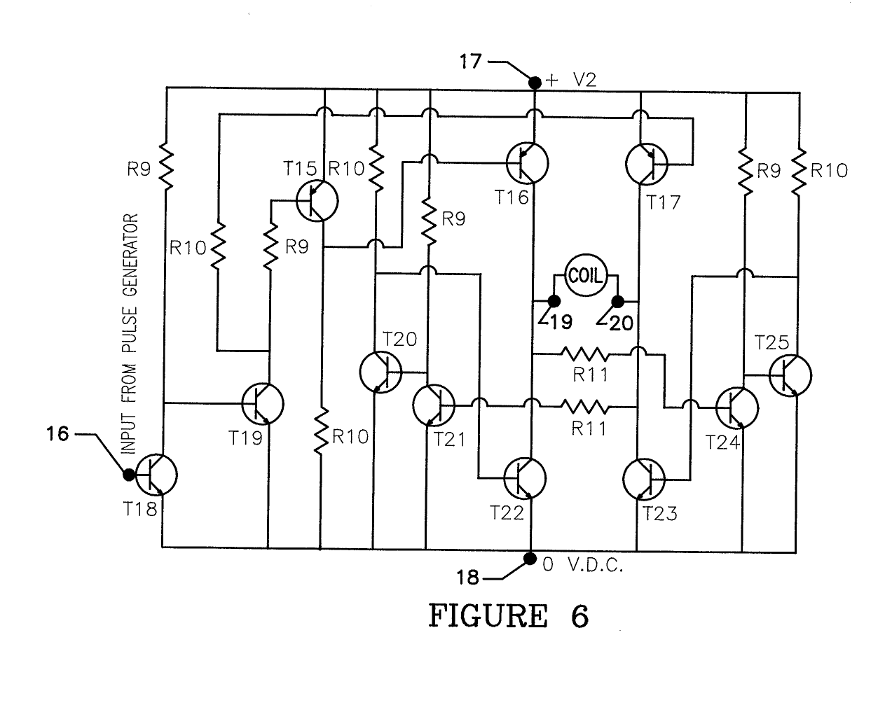

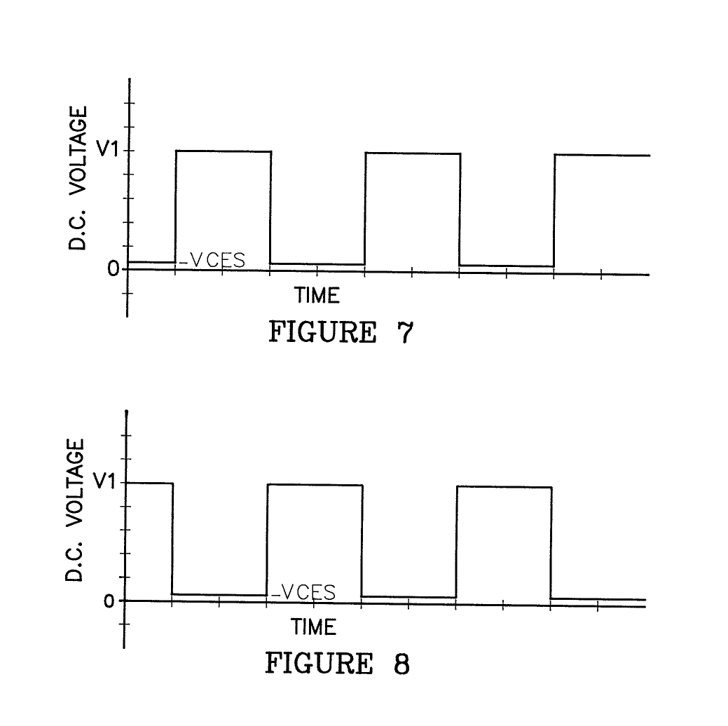

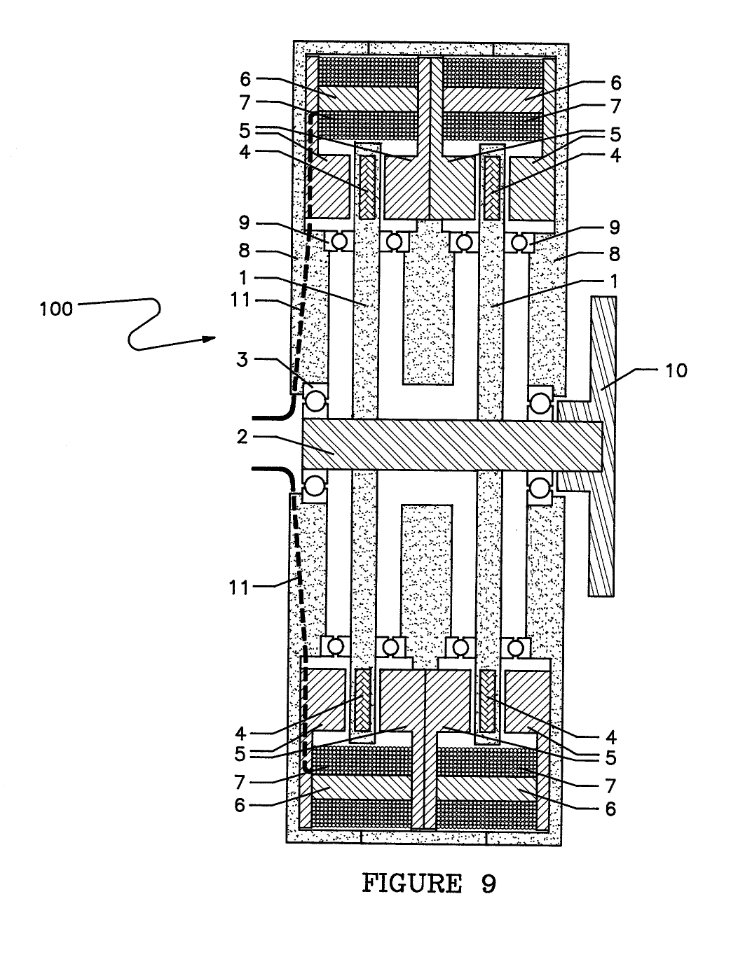

The speed of rotation of motor 100 may be controlled by controlling the cycle time and polarity of the voltage applied to individual ones of the coils 7 by external driving circuitry. The following description is with reference to the detailed circuit diagrams of FIGS. 5 and 6 and the waveform diagrams of FIGS. 7 and 8. Applying a D.C. voltage +V1 between terminals 14 and 15 of the circuit of FIG. 5 will result in a voltage on terminal 12 that will vary between +V1 and Vces with respect to reference terminal 15, where voltage Vces is the voltage drop across device T5 in its saturation region, as illustrated in the waveform diagram of FIG. 7. The time spacing between pulses and the pulse width will be determined by the product of the sum of the resistances of resistors R7 and R8 and capacitance C. Substituting a variable resistor for R8 allows the user to vary the spacing and width of the voltage pulses at terminal 12. The voltage pulses at terminal 13 will be of the same magnitude as those at terminal 12, except that they will be 180 degrees out of phase therewith. That is, when the voltage at terminal 12 is +V1, the voltage at terminal 13 is Vces, and when the voltage at terminal 12 is Vces, the voltage at terminal 13 is V1, as illustrated by the waveform diagram of FIG. 8. The voltage pulses produced by the circuit of FIG. 5 are applied to terminal 16 of each one of a plurality of driver circuits like that illustrated in FIG. 6. The number of driver circuits provided may correspond to the number of coils 7, or one driver circuit may be arranged to drive two or more of the coils 7. Each one of the coils 7 is connected between output terminals 19 and 20 of its associated driver circuit, as shown in FIG. 6, by means of conductors 11 illustrated in FIGS. 1, 3, 4, and 9. If desired, plug-in connectors may be provided at the ends of conductors 11 that connect to the external driver circuits of FIG. 6 to facilitate replacing motor 100, should it ever become necessary to do so. A positive voltage of magnitude +V1 at terminal 16 with respect to the reference voltage at terminal 18 will result in coil terminal 20 being positive with respect to coil terminal 19. A voltage Vces at input terminal 16 with respect to the reference voltage at terminal 18 will result in coil terminal 19 being positive with respect to coil terminal 20. The magnitude of the voltage between terminals 19 and 20 is equal to V2-2Vces. Thus, if the input to the coil driver circuitry of FIG. 6 for adjacent ones of coils 7 is alternated between output terminals 12 and 13, the polarity on adjacent ones of the pairs of pole pieces 5 will also alternate. The reference voltage in the circuits of FIGS. 5 and 6 should be the same. However, the voltages V1 and V2 need not be the same. Changing the voltage V1 will alter the pulse spacing and width, while changing the voltage V2 will alter the output torque of the motor 100.

One variation of the motor 100 of FIG. 1 is the addition of one or more rotors 1 on the common shaft 2, as illustrated in FIG. 9, in order to increase the available power supplied to shaft 2. Another variation would be the use of coils with an associated core in place of the permanent magnets 4 encased in rotor 1. This arrangement would require either slip rings or a commutator on rotor 1, the choice being dependent on whether the voltage polarity is to be switched on the rotor coils 7 or the coils associated with the pairs of pole pieces 5.

I claim:

1. A disk type D.C. motor comprising:
a stationary case constructed of a non-ferrous material;
a motor shaft positioned within the case on a central axis of the motor;
a rotor fixedly attached to said motor shaft perpendicular to said central axis, said rotor being in the shape of a circular disk;
an even plurality of magnets encased within said rotor equally spaced proximate a peripheral edge thereof, adjacent ones of the plurality of magnets being of opposite magnetic polarity;
a like plurality of pairs of facing ferromagnetic pole pieces fixedly mounted within said case, each pair of facing pole pieces being spaced in correspondence with said plurality of magnets, the facing pole pieces of each pair being positioned on opposite sides of said rotor in spaced proximity to one of said plurality of magnets, the facing pole pieces of each pair being in firm contact with a core that is mounted within said case outside said peripheral edge of said rotor, each of the cores being wound with a coil such that an electric current flowing in the coil induces a magnetic polarity in an associated pair of pole pieces.

2. A motor as in claim 1, further comprising electronic circuitry for selectively energizing the coils wound around each of the cores.

3. A motor as in claim 2, wherein said electronic circuitry is operative for controlling cycle time and polarity of a voltage applied to each of the coils to thereby control the speed of the motor.

4. A motor as in claim 1, further comprising an output flange fixedly attached to said motor shaft for coupling the motor to a load.

5. A motor as in claim 1, wherein said plurality of magnets comprises a plurality of permanent magnets.

6. A motor as in claim 1, wherein said plurality of magnets comprises a plurality of electromagnets.

7. A disk type D.C. motor comprising:
a stationary case constructed of a non-ferrous material;
a motor shaft positioned within the case on a central axis of the motor;
a plurality of rotors fixedly attached to said motor shaft perpendicular to said central axis and parallel to each other, each of said rotors being in the shape of a circular disk;
an even plurality of magnets encased within each of said rotors equally spaced proximate a peripheral edge thereof, adjacent ones of the plurality of magnets being of opposite magnetic polarity;
a like plurality of pairs of facing ferromagnetic pole pieces fixedly mounted within said case, each pair of facing pole pieces being spaced in correspondence with said plurality of magnets, the facing pole pieces of each pair being positioned on opposite sides of each of said rotors in spaced proximity to one of said plurality of magnets, the facing pole pieces of each pair being in firm contact with a core that is mounted within said case outside said peripheral edge of each of said rotors, each of the cores being wound with a coil such that an electric current flowing in the coil induces a magnetic north-south polarity in an associated pair of pole pieces.

8. A motor as in claim 7, further comprising electronic circuitry for selectively energizing the coils wound around each of the cores.

9. A motor as in claim 8, wherein said electronic circuitry is operative for controlling a cycle time and polarity of a voltage applied to each of the coils to thereby control the speed of the motor.

10. A motor as in claim 7, further comprising an output flange fixedly attached to said motor shaft for coupling the motor to a load.

11. A motor as in claim 7, wherein said plurality of magnets comprises a plurality of permanent magnets.

12. A motor as in claim 7, wherein said plurality of magnets comprises a plurality of electromagnets.
